(19) United States
(12) Patent Application Publication
(10) Pub. No.: US 2024/0399845 A1
(43) Pub. Date: Dec. 5, 2024

(54) FASTENING STRUCTURE FOR VEHICULAR MOUNTING SYSTEM

(71) Applicants: HYUNDAI MOTOR COMPANY, Seoul (KR); KIA CORPORATION, Seoul (KR); PYUNG HWA INDUSTRIAL CO., LTD., Daegu (KR)

(72) Inventors: Jae Hyung Yun, Ansan-si (KR); Gu Gyun Kwon, Seoul (KR); Sang Hoon Han, Hwaseong-si (KR); Young Deuk Seo, Changwon-si (KR); Byeong Gon Lee, Daegu (KR)

(73) Assignees: HYUNDAI MOTOR COMPANY, Seoul (KR); KIA CORPORATION, Seoul (KR); PYUNG HWA INDUSTRIAL CO., LTD., Daegu (KR)

(21) Appl. No.: 18/524,616

(22) Filed: Nov. 30, 2023

(30) Foreign Application Priority Data
Jun. 5, 2023 (KR) 10-2023-0072023

(51) Int. Cl. B60K 5/12

(52) U.S. Cl. CPC B60K 5/12

(57) ABSTRACT

A fastening structure for a vehicular mounting system includes: a mount core including an inner core and coupled to a vehicle body by being fixed thereto, a center bolt protruding in an upward direction from the inner core, and a support bracket mounted on the inner core in such a manner as to come into contact therewith. The support bracket is fastened to the mount core using the center bolt and coupled to a powertrain of a vehicle by being fixed thereto. In particular, the center bolt passes through the inside of the support bracket, and a mounting seating surface, on which the support bracket is seated, is formed on an upper surface of the inner core. The mounting seating surface includes a counterforce angle formation portion.

### CROSS-REFERENCE TO RELATED APPLICATION

This application claims under 35 U.S.C. § 119(a) the benefit of and priority to Korean Patent Application No. 10-2023-0072023 filed on Jun. 5, 2023, the entire contents of which are incorporated herein by reference.

### BACKGROUND

### (a) Technical Field

The present disclosure relates to a fastening structure for a vehicular mounting system, which is capable of improving stability of fastening between a support bracket and a mount.

### (b) Background Art

Usually, an engine of a vehicle is installed in an engine room of a vehicle body through an engine mount in order to insulate and attenuate a vibration of the engine. For a passenger vehicle, a lever engine mount, a pneumatic engine mount, and a hydraulic engine mount (fluid-filled engine mount) are widely used. The lever engine mount insulates and attenuates vibration using an elastic force of a lever. The pneumatic engine mount obtains a damping force by causing air to flow into and out of a case. The hydraulic engine mount is filled with a predetermined amount of hydraulic fluid.

A fastening structure for an engine mount in the related art is described below. The engine mount in the shape of a cylinder has a center bolt protruding from an upper surface thereof and is fixed to a vehicle body through fixation brackets. Both end portions of a support bracket are formed with bolt holes into which the center bolts are respectively are inserted. One end portion of the support bracket is seated on the engine mount and is fixed thereto using nuts configured to engage the center bolts. The other end portion of the support bracket is connected to an engine bracket extending from an engine body. Thus, the engine mount supports the weight of the engine.

In the structure as described above, the support bracket is configured in a manner that is separated or fastened according to an upward-downward direction. The reason for employing this configuration (the reason in which the support bracket is fastened in the upward-downward direction instead of being fastening in a leftward-rightward direction of the engine mount) is because stud bolts are mostly used as the center bolts and bolts pre-fastened to the engine bracket in order to improve workability in a manufacturing factory.

Accordingly, when the support bracket is not fastened in the upward-downward direction, the support bracket cannot be inserted at a point where the center bolt of the engine mount is fastened and two points where the bolts of the engine bracket are fastened. As a result, assembling is impossible.

In another form, instead of using the stud bolts, the support bracket having respective heads may be fastened using typical bolts, but by inserting the typical bolts along the leftward-rightward direction. However, when this method is employed, it becomes difficult for an operator on an assembly line to align positions of the bolt holes drilled in the support bracket, which decreases workability. Consequently, an increase in working time leads to an increase in manufacturing costs.

in other words, because the support bracket in the related art is mounted in the upward-downward direction, a point where the support bracket and the center bolt are connected to each other is set to be positioned at a higher height than a point where the support bracket and the engine bracket are fastened to each other. It poses a problem in that the greater the height difference, the more it can adversely affect the stiffness of the structure.

Therefore, in order to compensate for the reduction in stiffness, the bracket should be manufactured with higher stiffness material and have greater thickness. In addition, a damper should be added to address the resonance frequency variations due to the stiffness reduction, resulting in increased weight and production costs.

The statements in this BACKGROUND section merely provide background information related to the present disclosure and may not constitute prior art.

### SUMMARY OF THE DISCLOSURE

Embodiments of the present disclosure provide a fastening structure for a vehicular mounting system. In the fastening structure, when a support bracket behaves due to an external force, a counterforce angle defined as an inclination angle that creates a resistance force against the behavior is formed at a position where the support bracket and a mount core come into contact with each other. Thus, a direction of a concentrated load due to the external force is guided toward a direction of a tensile force of a fastening bolt before a fastening surface undergoes deformation, resulting in distribution of the concentrated load. In the fastening structure, this guidance can achieve the effect of improving the stability of fastening between the support bracket and the mount core.

In another embodiment of the present disclosure, a fastening structure for a vehicular mounting system includes: a mount core including an inner core and coupled to a vehicle body by being fixed thereto, and a center bolt protruding in an upward direction from the inner core. The fastening structure further includes a support bracket mounted on the inner core in such a manner as to come into contact therewith. The support bracket is fastened to the mount core using the center bolt and coupled to a powertrain of a vehicle by being fixed thereto, and the center bolt passes through the inside of the support bracket. In particular, a mounting seating surface, on which the support bracket is seated, is formed on an upper surface of the inner core, and the mounting seating surface includes a counterforce angle formation portion.

In the fastening structure, the mounting seating surface is formed to be inclined in a direction in which a load is input at a front end thereof.

In the fastening structure, the support bracket may include a mounting area, and the support bracket is mounted on the inner core through the mounting area. The mounting area may include a through-hole through which the center bolt passes, and an inclination member that is formed in a manner that corresponds to the counterforce angle formation portion.

In the fastening structure, when an external force is applied toward a lateral direction in which the counterforce angle formation portion is formed, or when a combined external force is applied toward the lateral direction and the upward direction, the mounting seating surface may guide a load in a manner that is distributed toward a direction of a tensile force through the counterforce angle formation portion.

In the fastening structure, when a combined external force is applied toward a lateral direction in which the counterforce angle formation portion is formed and a downward direction, the mounting seating surface may guide a load in a manner that is distributed by a surface contact with the counterforce angle formation portion.

in other embodiment of the present disclosure, a fastening structure for a vehicular mounting system includes: a mount core including an inner core and coupled to a vehicle body by being fixed thereto, and a center bolt protruding in an upward direction from the inner core. The fastening structure further includes a support bracket mounted on the inner core in such a manner as to come into contact therewith and fastened to the mount core using the center bolt. The support bracket is coupled to a power electronics module of a vehicle by being fixed thereto, and the center bolt passes through the inside of the support bracket. In particular, a mounting seating surface on which the support bracket is seated is formed on an upper surface of the inner core, and the mounting seating surface includes a counterforce angle formation portion.

In the fastening structure, the mounting seating surface is formed to be inclined in a direction in which a load is input at a front end thereof.

In the fastening structure, the support bracket may include a mounting area, the support bracket being mounted on the inner core through the mounting area. The mounting area may include a through-hole through which the center bolt passes, and an inclination member that is formed in a manner that corresponds to the counterforce angle formation portion.

In the fastening structure, when an external force is applied toward a lateral direction in which the counterforce angle formation portion is formed, or when a combined external force is applied toward the lateral direction and an upward direction, the mounting seating surface may guide a load in a manner that is distributed toward a direction of a tensile force through the counterforce angle formation portion.

In the fastening structure, when a combined external force is applied toward a lateral direction in which the counterforce angle formation portion is formed and a downward direction, the mounting seating surface may guide a load in a manner that is distributed by a surface contact with the counterforce angle formation portion.

According to the present disclosure, when an external force acts on the support bracket, a counterforce angle, defined as an inclination angle that creates a resistance force against the reaction, is formed at a position where the support bracket and the mount core come into contact with each other. Thus, a direction of the concentrated load due to the external force is guided toward a direction of a tensile force of a fastening bolt before a fastening surface undergoes deformation, resulting in distribution of the concentrated load. This guidance can achieve the effect of improving the stability of the fastening between the support bracket and the mount core.

Consequently, according to the present disclosure, a material, such as a steel material, that has a high surface hardness is not separately applied to the fastening surface between the support bracket and the mount core, but the loosening of the fastening bolt due to the external force can be prevented by forming the counterforce angle. This configuration can achieve the effect of improving fastening performance without an increase in manufacturing costs and weight.

### BRIEF DESCRIPTION OF THE DRAWINGS

The above and other features of the present disclosure are now described in detail with reference to certain examples thereof illustrated in the accompanying drawings which are given herein below by way of illustration only, and thus are not limitative of the present disclosure, and wherein:

FIG. 1 is a view schematically illustrating a fastening structure for a vehicular mounting system according to an embodiment of the present disclosure;

FIG. 2 is a view illustrating a state where a support bracket is mounted with respect to an inner core in the fastening structure for a vehicular mounting system according to the embodiment of the present disclosure;

FIG. 3 is a view illustrating the inner core in the fastening structure for a vehicular mounting system according to the embodiment of the present disclosure;

FIG. 4 is a view illustrating the support bracket in the fastening structure for a vehicular mounting system according to the embodiment of the present disclosure;

FIG. 5 is a cross-sectional view taken along line A-A on FIG. 1, illustrating a state where the support bracket is fastened to a mount core in the fastening structure for a vehicular mounting system according to the embodiment of the present disclosure;

FIGS. 6A to 6D are views each schematically showing a load path in a square area on FIG. 5 that is subject to a direction in which an external force is applied to the fastening structure for a vehicular mounting system according to the embodiment of the present disclosure; and

FIGS. 7 and 8 are views each illustrating a fastening structure for a vehicular mounting system in the related art.

### DETAILED DESCRIPTION

Embodiments of the present disclosure are described in detail below with reference to the accompanying drawings.

An advantage of the present disclosure and a feature thereof and a method of achieving the advantage and the feature should be apparent from the embodiments that are described below in detail with reference to the accompanying drawings.

However, the present disclosure is not limited to the embodiments that are disclosed below and should be practiced in various different forms. The embodiments are only provided to enhance the understanding of the present disclosure and to provide a person of ordinary skill in the art to which the present disclosure pertains with definite notice as to the scope of the present disclosure.

In addition, a detailed description of a well-known technology or the like related to the present disclosure, when determined as making the gist and nature of the present disclosure obfuscated, has been omitted.

When a component, device, element, or the like of the present disclosure is described as having a purpose or performing an operation, function, or the like, the component, device, or element should be considered herein as being “configured to” meet that purpose or to perform that operation or function.

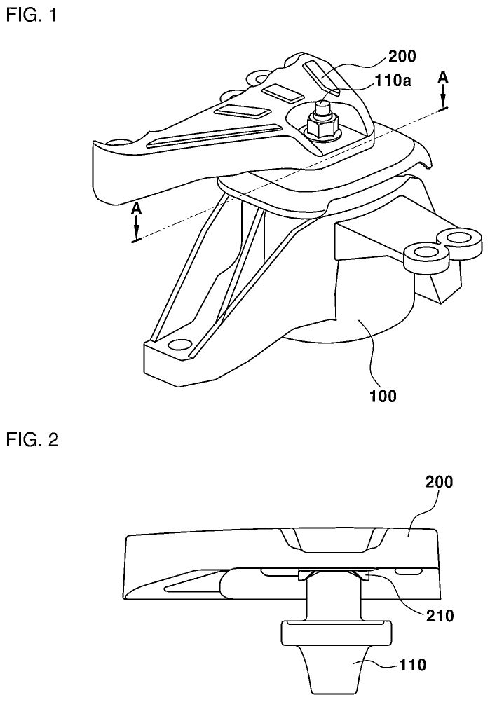

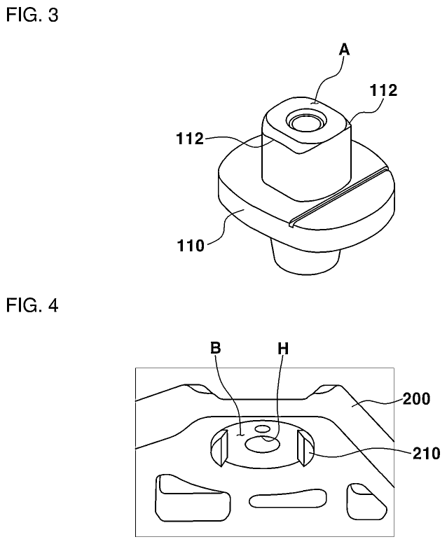

FIG. 1 is a view schematically illustrating a fastening structure for a vehicular mounting system according to an embodiment of the present disclosure. FIG. 2 is a view illustrating a state where a support bracket 200 is mounted with respect to an inner core 110 in the fastening structure for a vehicular mounting system according to the embodiment of the present disclosure.

FIG. 3 is a view illustrating the inner core 110 in the fastening structure for a vehicular mounting system according to the embodiment of the present disclosure.

FIG. 4 is a view illustrating the support bracket 200 in the fastening structure for a vehicular mounting system according to the embodiment of the present disclosure.

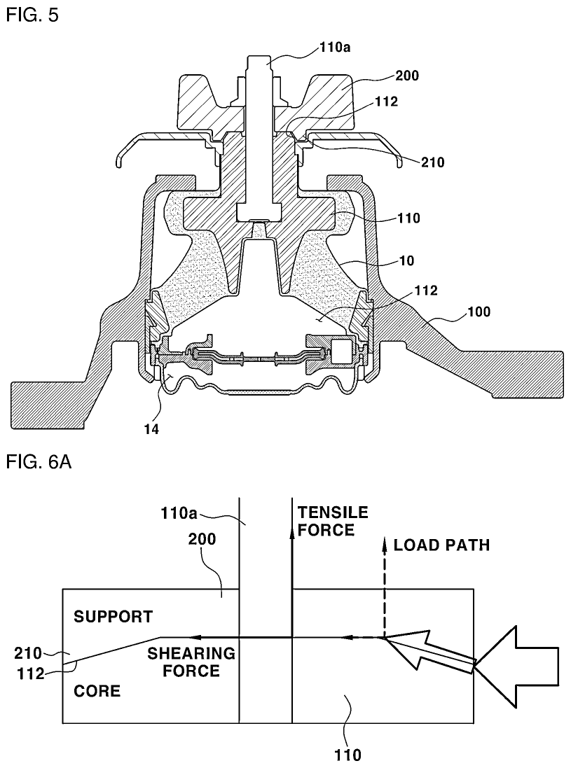

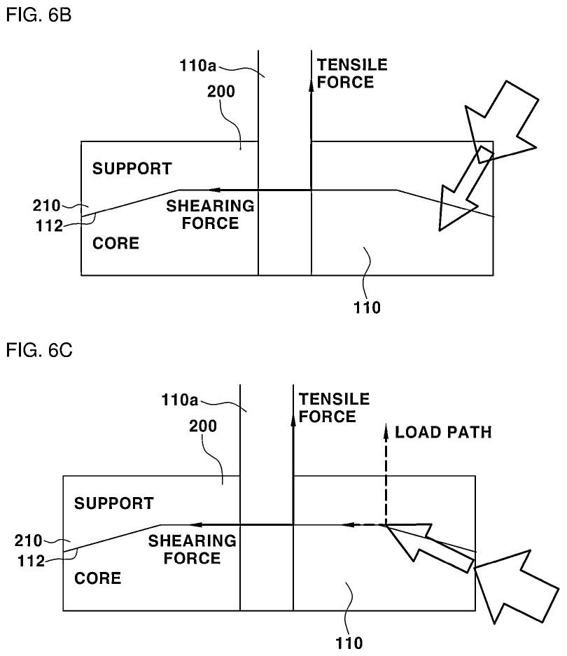

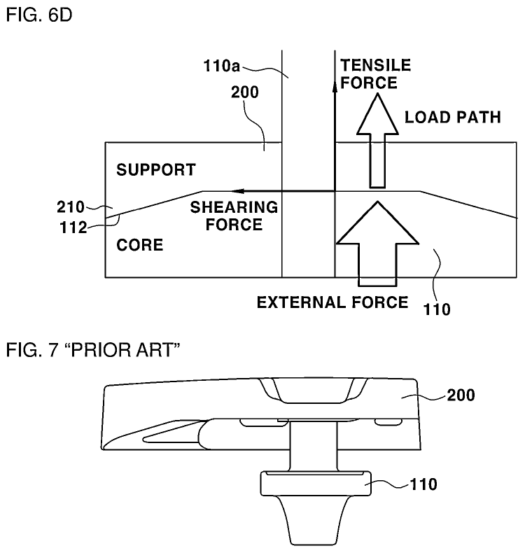

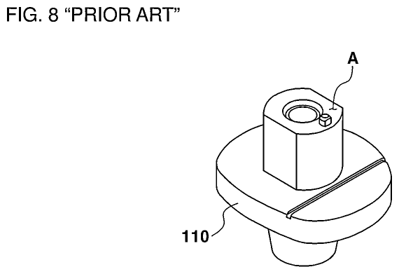

FIG. 5 is a cross-sectional view taken along line A-A on FIG. 1, illustrating a state where the support bracket 200 is fastened to a mount core 100 in the fastening structure for a vehicular mounting system according to the embodiment of the present disclosure. FIGS. 6A to 6D are views each schematically showing a load path in a square area on FIG. 5 that is subject to a direction in which an external force is applied to the fastening structure for a vehicular mounting system according to the embodiment of the present disclosure. FIGS. 7 and 8 are views each illustrating a fastening structure for a vehicular mounting system in the related art.

A typical vehicular mounting system is configured with an engine mount, a transmission (TM) mount, and a roll mount in the case of a powertrain (PT) and is configured with a motor mount and a decelerator mount in the case of a power electronics (PE) module.

In the case, these mounts serve the main purpose of supporting loads on the PT and/or the PE modules and providing insulation from various behaviors (behaviors of PE modules, external forces, and the like).

Accordingly, the mounts withstand high-load and large-displacement behaviors and receive vibrations in a frequency band from a low frequency to 3000 Hz.

The mounts, which receive this vibration, typically encounter a common problem of a fastening bolt becoming loose. When a fastening bolt loosens, the axial force decreases, which can lead to breakage.

In addition, when the axial force decreases due to the loosening of the fastening bolt or similar factors, the seating surface of an object that is secured with the fastening bolt may deform, resulting in a decrease in axial force.

In order to solve this problem, various methods, such as using a self-locking bolt, a flange expansion bolt, and a spring washer assembly bolt, have been employed in the related art. In addition, in order to keep a fastening force stabilized, a material with a high surface hardness (a steel material or the like) may be separately applied to a fastening surface of the object secured with the fastening blot.

For this reason, high-priced materials and processing techniques are used. As an example, static strength and fatigue strength can be enhanced by employing die casting. However, in order to keep the fastening force stabilized, the materials used need to be diversified, such as when employing a high-priced squeeze casting technique or when applying a separate steel seating surface.

The high-priced material and processing techniques are also used in order to stabilize fastening torque, as well as preventing the bolt loosening, during an assembling process. However, in this case, when a material has a low surface hardness, a bolt burrows into a fastening surface while being fastened. Accordingly, even when the bolt is not fastened with as much torque as is required in an actual drawing, a high torque measurement is obtained due to friction, resulting in the bolt being less tightened. Thus, torque that exceeds a reference numerical value may be occasionally applied, thereby causing the bolt to be broken.

In order to solve this problem, the fastening structure for a vehicular mounting system according to an embodiment of the present embodiment, as illustrated in FIGS. 1 and 2, is configured as a structure in which the support bracket 200 is mounted on the mount core 100 including the inner core 100. In this case, a counterforce angle formation portion 112, as illustrated in FIG. 3, is formed on an upper surface of the inner core 110.

In other words, the mount core 100 includes the inner core 110 and is coupled to a vehicle body by being fixed thereto. A center bolt 110a protrudes in an upward direction from the inner core 110. In addition, the support bracket 200 is mounted on the inner core 110 in such a manner as to come into contact therewith, and is fastened to the mount core 100 using the center bolt 110a that passes through the inside of the support bracket 200.

In one embodiment, the support bracket 200 may be coupled to a powertrain (PT), for example, an engine, of a vehicle by being fixed thereto, and configured to absorb vibrations caused by an external force. However, as an implementation example, the support bracket 200 is described, taking for example the vehicle equipped with the engine, and thus is not limited thereto. In another embodiment, the support bracket 200 may also be coupled to a power electronics (PE) module, for example, a motor, of an electric vehicle, as well as powertrain, by being fixed thereto, and configured to absorb vibrations caused by an external force.

In the structure as described above, as illustrated in FIG. 3, a mounting seating surface A on which the support bracket 200 is seated is formed on the upper surface of the inner core 110. An inclination angle formation portion, i.e., the counterforce angle formation portion 112, is formed on the mounting seating surface A. When the external force acts on the support bracket 200, the counterforce angle formation portion 112 causes a resistance force against the reaction of the support bracket 200. As a result, a problem can be prevented, such as the loosening of the center bolt 110a due to the external force.

In other words, when the vehicle travels, vibrations that occur by the engine within a specific RPM range is usually transferred at a specific frequency to the interior of the vehicle through the vehicle body. Consequently, combustion noise and vibrations of the engine significantly impacts the interior of the vehicle.

For this reason, the engine mount is mounted between the engine of the vehicle and the vehicle body. The engine mount not only supports the engine, but also attenuates noise and vibrations that are transferred from the engine to the interior of the vehicle through the vehicle body. As illustrated in FIG. 5, to this end, an insulator 10 and an operating fluid (not illustrated) are used in order to absorb the vibrations of the engine. The insulator 10 is attached to the mount core 100 and receives the vibrations of the engine. The operating fluid absorbs the vibrations of the engine while flowing through a flow path between an upper chamber 12 arranged under the insulator 10 and a lower chamber 14.

However, when the engine mount repeatedly withstands high-load and large-displacement behaviors or receives the vibrations in a frequency band from a low frequency to 3000 Hz, the loosening of the center bolt 110a or the like may occur due to the behavior of the support bracket 200. Because of this, in preparation against an external force that is exerted by the high-load and large-displacement behaviors, the center bolt 110a is fastened to the support bracket 200 in a state where the counterforce angle formation portion 112 is formed on the upper surface of the inner core 110. Accordingly, a load, in a direction of a shearing force, that is applied toward the center bolt 110a is guided toward a direction of a tensile force, resulting in possibly stabilizing a fastening force for preventing the loosening of the center bolt 110a.

In one embodiment, as illustrated in FIG. 3, the counterforce angle formation portion 112 is formed in such a manner to be inclined downward along a forward-backward direction of the mounting seating surface A.

For example, the counterforce angle formation portion 112 is formed in a downward inclined manner at an angle of 30 degrees or less with respect to the mounting seating surface A. When the counterforce angle formation portion 112 is formed in a downward inclined manner at an angle of more than 30 degrees, the load is difficult to distribute toward the direction of the tensile force. Furthermore, due to the angle of more than 30 degrees, a resistance force toward a direction in which the external force is applied cannot be distributed in a surface contact manner. As a result, deformation of the mounting seating surface A cannot be prevented.

In addition, a mounting area B of the support bracket 200 that is fastened to the counterforce angle formation portion 112, as illustrated in FIG. 4, includes a through-hole H and a pair of inclination members 210. The center bolt 110a passes through the through-hole H. The inclination members 210 in a pair are inclined in a manner that corresponds to the counterforce angle formation portion 112 formed on the mounting seating surface A. Accordingly, the mount core 100 and the support bracket 200 may be fastened to each other using the center bolt 110a in a state where the mounting seating surface A and the mounting area B that are correspondingly positioned come into contact with each other.

The mount core 100 and the support bracket 200 are fastened to each other, ensuring that the counterforce angle formation portion 112 on the mounting seating surface A and the mounting area B come into contact with each other. Consequently, the load is distributed according to the directions in which different external forces are exerted. Thus, the center bolt 110a can be prevented from being loosened due to the external force transferred to the support bracket 200.

In one form, the counterforce angle formation portion 112 formed on the mounting seating surface A and the inclination member 210 come into contact with each other, for example, when an external force, as illustrated in FIG. 6A, is applied toward a lateral direction in which the counterforce angle formation portion 112 is formed, or when a combined external force, as illustrated in FIG. 6C, is applied toward the lateral direction and the upward direction. Through an inclination surface formed when the counterforce angle formation portion 112 and the inclination member 210 come into contact with each other, the load transferred toward the direction of the shearing force may be guided in a manner that is distributed toward the direction of the tensile force that is generated by the fastening with the center bolt 110a.

With reference to FIGS. 7 and 8, in the related art, due to a structure of the flat mounting seating surface A, a load in the direction of the shearing force that is applied toward the mounting seating surface A when the load is transferred concentrates toward front and rear edges of the mounting seating surface A, thereby causing deformation. Furthermore, due to the structure of the flat mounting seating surface A, the load, when transferred, is not distributed, thereby causing the center bolt 110a to be loosened.

In the embodiments of the present disclosure, as illustrated in FIG. 6B, when the combined external force is applied in the lateral direction in which the counterforce angle formation portion 112 is formed on the mounting seating surface A and a downward direction, a load that would have been distributed by linear contact as in the case a structure in the related art is guided in a manner that is distributed by a surface contact with the counterforce angle formation portion 112, thereby preventing the deformation of the mounting seating surface A.

Moreover, as illustrated in FIG. 6D, when an external force is applied in the upward direction, the tensile force generated by the fastening with the center bolt 110a is maintained, thereby preventing the deformation of the mounting seating surface A.

In other words, according to the present embodiment, the counterforce angle formation portion 112 formed in a manner that is inclined along the forward-backward direction of the mounting seating surface A is provided, and the inclination member 210 is correspondingly provided on the mounting area B of the support bracket 200, resulting in the fastening of the mount core and 100 and the support bracket 200 to each other. Thus, through the optimization of the fastening structure, it is possible to prevent a potential decrease in axial force and guide the direction of the load using the tensile force of the center bolt 110a. This occurs before the mounting seating surface A undergoes deformation when subject to an external force. As a result, the stabilization of a fastening force can be achieved.

According to the present disclosure, when the external force acts on the support bracket 200, a counterforce angle defined as an inclination angle that creates a resistance force against the reaction of the support bracket 200 is formed at a position where the support bracket 200 and the mount core 100 come into contact with each other. Thus, a direction of a concentrated load due to the external force is guided toward a direction of a tensile force of a fastening bolt before a fastening surface undergoes deformation, resulting in distribution of the concentrated load. This guidance can achieve the effect of improving the stability of the fastening between the support bracket 200 and the mount core 100.

Consequently, according to the present disclosure, a material, such as a steel material, that has a high surface hardness is not separately applied to the fastening surface between the support bracket 200 and the mount core 100, but the loosening of the fastening bolt due to the external force can be prevented by forming the counterforce angle. This configuration can achieve the effect of improving fastening performance without an increase in manufacturing costs and weight.

The embodiments of the present disclosure are described above only in an exemplary manner with reference to the drawings. It would be understood by a person of ordinary skill in the art to which the present disclosure pertains that various modifications can be made to the embodiment and that some or all of the constituent elements of the embodiment described above may be selectively combined for configuration. Therefore, the proper scope of the present disclosure should be defined in the following claims.

What is claimed is:

1. A fastening structure for a vehicular mounting system, the fastening structure comprising:
a mount core including an inner core and coupled to a vehicle body by being fixed thereto, and a center bolt protruding in an upward direction from the inner core; and
a support bracket mounted on the inner core, fastened to the mount core using the center bolt, and coupled to a powertrain of a vehicle by being fixed thereto, the center bolt configured to pass through an inside of the support bracket,
wherein a mounting seating surface on which the support bracket is seated is formed on an upper surface of the inner core, and the mounting seating surface includes a counterforce angle formation portion.

2. The fastening structure of claim 1, wherein the mounting seating surface is formed to be inclined in a direction in which a load is input at a front end thereof.

3. The fastening structure of claim 1, wherein the support bracket includes a mounting area, the support bracket being mounted on the inner core through the mounting area, and
wherein the mounting area includes a through-hole through which the center bolt passes, and an inclination member that is formed in a manner that corresponds to the counterforce angle formation portion.

4. The fastening structure of claim 1, wherein, when an external force is applied toward a lateral direction in which the counterforce angle formation portion is formed, or when a combined external force is applied toward the lateral direction and the upward direction, the mounting seating surface is configured to guide a load to be distributed toward a direction of a tensile force through the counterforce angle formation portion.

5. The fastening structure of claim 1, wherein, when a combined external force is applied toward a lateral direction in which the counterforce angle formation portion is formed and a downward direction, the mounting seating surface is configured to guide a load to be distributed by a surface contact with the counterforce angle formation portion.

6. A fastening structure for a vehicular mounting system, the fastening structure comprising:
a mount core including an inner core and coupled to a vehicle body by being fixed thereto, and a center bolt protruding in an upward direction from the inner core; and
a support bracket mounted on the inner core, fastened to the mount core using the center bolt, and coupled to a power electronics module of a vehicle by being fixed thereto, the center bolt configured to pass through an inside of the support bracket,
wherein a mounting seating surface on which the support bracket is seated is formed on an upper surface of the inner core, and the mounting seating surface includes a counterforce angle formation portion.

7. The fastening structure of claim 6, wherein the mounting seating surface is formed to be inclined in a direction in which a load is input at a front end thereof.

8. The fastening structure of claim 6, wherein the support bracket includes a mounting area, the support bracket being mounted on the inner core through the mounting area, and
wherein the mounting area includes a through-hole through which the center bolt passes, and an inclination member that is formed in a manner that corresponds to the counterforce angle formation portion.

9. The fastening structure of claim 6, wherein, when an external force is applied toward a lateral direction in which the counterforce angle formation portion is formed, or when a combined external force is applied toward the lateral direction and an upward direction, the mounting seating surface is configured to guide a load to be distributed toward a direction of a tensile force through the counterforce angle formation portion.

10. The fastening structure of claim 6, wherein, when a combined external force is applied toward a lateral direction in which the counterforce angle formation portion is formed and a downward direction, the mounting seating surface is configured to guide a load to be distributed by a surface contact with the counterforce angle formation portion.
